(19) United States
(12) Patent Application Publication
(10) Pub. No.: US 2026/0171418 A1
(43) Pub. Date: Jun. 18, 2026

(54) POLYMER SOLID ELECTROLYTE COMPOSITION FOR LITHIUM SECONDARY BATTERY, AND USE THEREOF

(71) Applicant: LOTTE CHEMICAL CORPORATION, Seoul (KR)

(72) Inventors: Hyun Jin Jung, Seoul (KR); Jae Yun Park, Seoul (KR); Sang Sun Park, Seoul (KR); Se Ho Park, Seoul (KR); Young Min Baek, Seoul (KR); Mi Jin Jung, Seoul (KR)

(73) Assignee: LOTTE CHEMICAL CORPORATION, Seoul (KR)

(21) Appl. No.: 19/124,558

(22) PCT Filed: Nov. 16, 2023
(86) PCT No.: PCT/KR2023/018428

§ 371 Date: Apr. 25, 2025

(30) Foreign Application Priority Data
Nov. 30, 2022 (KR) 10-2022-0165195

(51) Int. Cl. H01M 4/62; H01M 4/02; H01M 4/131; H01M 4/36; H01M 4/485; H01M 4/66; H01M 10/052; H01M 10/0525; H01M 10/0562; H01M 10/0565

(52) U.S. Cl. CPC H01M 4/622; H01M 4/131; H01M 4/366; H01M 4/485; H01M 4/62; H01M 4/661; H01M 10/052; H01M 10/0525; H01M 10/0562; H01M 10/0565; H01M 2004/028; H01M 2300/0082

(57) ABSTRACT

The present disclosure relates to a polymer solid electrolyte composition for a lithium secondary battery and a use thereof. Particularly, the present disclosure relates to a polymer solid electrolyte composition for a lithium secondary battery, a polymer solid electrolyte for a lithium secondary battery, and a lithium secondary battery. The present disclosure can simultaneously improve the ionic conductivity and mechanical strength of a polymer electrolyte.

### TECHNICAL FIELD

The present disclosure relates to a polymer solid electrolyte composition for a lithium secondary battery and a use thereof.

Particularly, the present disclosure relates to a polymer solid electrolyte composition for a lithium secondary battery, a polymer solid electrolyte for a lithium secondary battery, and a lithium secondary battery.

### BACKGROUND ART

Demand for secondary batteries is increasing in various fields, such as PCs, mobile phones, electric vehicles, and energy storage devices. Among secondary batteries, particularly, a lithium secondary battery has a higher capacity density than other secondary batteries and operates even at high voltages.

The lithium secondary battery generally consists of a cathode (reduction electrode); an anode (oxidation electrode); and an electrolyte interposed between the cathode and the anode and containing a lithium salt. The electrolyte includes a non-aqueous liquid electrolyte or a solid electrolyte. The non-aqueous liquid electrolyte penetrates into the inside of the cathode. Therefore, the non-aqueous liquid electrolyte may provide high electrical performance by easily forming an interface between the active material of the cathode and the electrolyte.

However, the non-aqueous liquid electrolyte is vulnerable to ignition due to overcurrent and the like caused by short circuits, etc., by using flammable organic solvents. Therefore, the non-aqueous liquid electrolyte requires the installation of separate safety devices, selection of special battery materials, etc., and limits a battery structural design. This causes increased manufacturing costs and decreased productivity of the lithium secondary battery.

All-solid-state batteries replace liquid electrolytes with solid electrolytes. The all-solid-state batteries have no disadvantage of using flammable organic solvents. Therefore, the advantages of all-solid-state batteries are low manufacturing costs and excellent productivity. In addition, the all-solid-state batteries have a simple structure. Therefore, the advantages of the all-solid-state battery structure are excellent stability and high capacity and output.

Types of solid electrolytes include a sulfide solid electrolyte, an oxide solid electrolyte, a polymer solid electrolyte, and the like. The sulfide solid electrolyte and the oxide solid electrolyte need to be compressed at high temperature and pressure due to high interfacial resistance. It is advantageous that the polymer solid electrolyte may be manufactured under normal conditions (room temperature and atmospheric pressure).

However, the disadvantages of the polymer solid electrolyte are insufficient ionic conductivity and mechanical strength. In particular, the ionic conductivity and mechanical strength of the polymer electrolyte have a trade-off relationship, so that it is difficult to improve both properties simultaneously.

Patent Document 1 discloses the addition of mesoporous tungsten oxide. However, the contents of Patent Document 1 are insufficient to sufficiently improve both the ionic conductivity and mechanical strength of an all-solid-state battery.

### PRIOR ARTS

### Patent Documents

(Patent Document 1) JP 5382634 B2 (Oct. 11, 2013)

### DISCLOSURE

### Technical Problem

An object of the present disclosure is to improve both ionic conductivity and mechanical strength of a polymer electrolyte.

### Technical Solution

According to an aspect of the present disclosure, a polymer solid electrolyte composition for a lithium secondary battery includes a polymer component; an organic solvent; a lithium salt; and a mesoporous tungsten oxynitride nanomaterial having a composition represented by Chemical Formula 1 below:

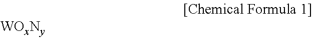

In Chemical Formula 1, x and y are 0.5 to 2.5, respectively.

According to another aspect of the present disclosure, a polymer solid electrolyte for a lithium secondary battery includes a polymer component; a lithium salt; and a mesoporous tungsten oxynitride nanomaterial having a composition represented by Chemical Formula 1 below:

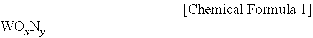

In Chemical Formula 1, x and y are 0.5 to 2.5, respectively.

According to yet another aspect of the present disclosure, a lithium secondary battery includes a solid electrolyte layer including the polymer solid electrolyte for the lithium secondary battery; a cathode layer disposed on one side of the solid electrolyte layer; and an anode layer disposed on the other side of the solid electrolyte layer so as to face the cathode layer.

### Advantageous Effects

According to the present disclosure, it is possible to improve both ionic conductivity and mechanical strength of a polymer electrolyte.

### DESCRIPTION OF DRAWINGS

FIG. 1 is a photograph of a polymer solid electrolyte composition of Example.

FIG. 2 is a photograph of a polymer solid electrolyte of Example.

FIG. 3 is a photograph of a polymer solid electrolyte of Example.

### MODES

### Polymer Solid Electrolyte Composition for Lithium Secondary Battery

The present disclosure relates to a polymer solid electrolyte composition for a lithium secondary battery.

The composition of the present disclosure is the polymer solid electrolyte composition for the ‘lithium secondary battery’ and thus includes a lithium salt.

The present disclosure does not limit the type of lithium salt. The lithium salt may be, for example, LiPF₆, LiBF₄, LiCF₃SO₃, Li(CF₃SO₂)₂N, Li(CF₃SO₂)₃C, LiC₂F₅SO₃, Li(FSO₂)₂N, LiC₄F₉SO₃, LiN(SO₂CF₂CF₃)₂, LiN(CN)₂, etc.

The present disclosure does not limit the content of lithium salt. The lithium salt may be added appropriately so that the electrolyte exhibits sufficient activity.

The composition of the present disclosure is the ‘polymer’ solid electrolyte composition for the lithium secondary battery and thus includes a polymer component.

The present disclosure does not limit the type of polymer component. The polymer component may be, for example, polyethylene oxide (PEO), polyvinylchloride (PVC), poly(methyl methacrylate) (PMMA), polyacrylonitrile (PAN), poly(vinylidene fluoride) (PVDF), poly(vinylidene fluoride-hexafluoropropylene) (PVDF-HFP), etc.

The present disclosure does not limit the content of the polymer component. The content of the polymer component is in the range of 5 parts by weight to 15 parts by weight with respect to 100 parts by weight of the organic solvent. The lower limit of the range (unit: parts by weight) is 6, 7, 8, 9 or 10. The upper limit of the range (unit: parts by weight) is 14, 13, 12, 11 or 10.

The composition of the present disclosure is the polymer solid electrolyte ‘composition’ for the lithium secondary battery and thus includes an organic solvent.

The present disclosure does not limit the type of organic solvent. The organic solvent may be, for example, N-methyl-2-pyrrolidinone, propylene carbonate, ethylene carbonate, butylene carbonate, dimethyl carbonate, diethyl carbonate, ethylmethyl carbonate, gamma-butyrolactone, 1,2-dimethoxyethane, 1,2-diethoxy ethane, tetrahydroxy franc, 2-methyl tetrahydrofuran, dimethyl sulfoxide, 1,3-dioxolane, 4-methyl-1,3-dioxene, diethyl ether, formamide, dimethylformamide, dioxolane, acetonitrile, nitromethane, methyl formate, methyl acetate, triester phosphate, trimethoxymethane, dioxolane derivatives, sulfolane, methyl sulfolane, 1,3-dimethyl-2-imidazolidinone, propylene carbonate derivatives, tetrahydrofuran derivatives, ether, methyl pyropionate, ethyl pyropionate, etc. Preferably, the organic solvent is ethylene carbonate.

The composition of the present disclosure is used for preparing a polymer solid electrolyte for the lithium secondary battery. Specifically, when the composition of the present disclosure is dried and the organic solvent is evaporated, the polymer solid electrolyte may be obtained.

As described above, the ionic conductivity and mechanical strength of the polymer electrolyte are insufficient, and it is difficult to simultaneously improve both properties. The composition of the present disclosure may simultaneously improve the ionic conductivity and mechanical strength of the polymer electrolyte by further including a specific component in the components. The composition of the present disclosure includes a mesoporous tungsten oxynitride nanomaterial. The mesoporous tungsten oxynitride nanomaterial may reduce the crystallinity of the polymer component to improve the ionic conductivity of the polymer electrolyte. In addition, the mesoporous tungsten oxynitride nanomaterial may be effectively dispersed in the electrolyte to improve the material strength of the polymer electrolyte.

The mesoporous tungsten oxynitride nanomaterial refers to a material having meso-sized pores, tungsten oxynitride, and a size in the nanometer unit.

The mesoporous material, that is, a mesoporous body refers to a material having pore sizes in the range of 2 nm to 20 nm. The pore size of the mesoporous tungsten oxynitride nanomaterial employed in the present disclosure may be within a specific range. For example, the pore size of the mesoporous tungsten oxynitride nanomaterial may be in the range of 3 nm to 10 nm.

The mesoporous tungsten oxynitride nanomaterial employed in the present disclosure is a specific tungsten oxynitride. Specifically, the mesoporous tungsten oxynitride nanomaterial has a specific compositional formula. The mesoporous tungsten oxynitride nanomaterial has a composition represented by the following Chemical Formula 1:

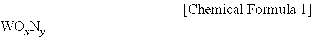

In Chemical Formula 1, x and y are 0.5 to 2.5, respectively. Preferably, each of x and y is 1.

The mesoporous tungsten oxynitride nanomaterial employed in the present disclosure may have a specific surface area. In one specific embodiment, the specific surface area of the mesoporous tungsten oxynitride nanomaterial may be in the range of 1 m²/g to 500 m²/g. The lower limit of the range (unit: m²/g) may be 5, 10, 15, 20 or 25. The upper limit of the range (unit: m²/g) may be 400, 300, 200, 100, 90, 80, 70, 60 or 50.

The present disclosure may further improve ionic conductivity and mechanical strength simultaneously by controlling the content of the mesoporous tungsten oxynitride nanomaterial. In other words, the present disclosure may improve the ionic conductivity and mechanical strength of the polymer solid electrolyte by applying the mesoporous tungsten oxynitride nanomaterial, and may further increase the degree of improvement by controlling the content (and/or form) thereof.

For example, the content of the mesoporous tungsten oxynitride nanomaterial may be in the range of 5 parts by weight to 30 parts by weight with respect to 100 parts by weight of the polymer component. Within the range, simultaneous improvement in ionic conductivity and mechanical strength of the polymer solid electrolyte may be maximized. Although described below, the range may be further specified depending on a form of the mesoporous tungsten oxynitride nanomaterial.

The mesoporous tungsten oxynitride nanomaterial employed in the present disclosure may largely have two forms. Specifically, the mesoporous tungsten oxynitride nanomaterial may be at least one of mesoporous tungsten oxynitride nanofibers and mesoporous tungsten oxynitride nanoparticles. That is, the mesoporous tungsten oxynitride nanomaterial may be mesoporous tungsten oxynitride nanofibers, mesoporous tungsten oxynitride nanoparticles, or a mixture of mesoporous tungsten oxynitride nanofibers and mesoporous tungsten oxynitride nanoparticles.

The mesoporous tungsten oxynitride nanofiber refers to the mesoporous tungsten oxynitride nanomaterial described above that has the form of fibers and has a size in the nanometer unit. For example, the average size of the mesoporous tungsten oxynitride nanofibers may be in the range of 1 nm to 100 nm. The lower limit of the size (unit: nm) may be 10, 20, 30, 40, 50, 60, 70 or 80.

The mesoporous tungsten oxynitride nanoparticle refers to the mesoporous tungsten oxynitride nanomaterial described above that has the form of particles and has a size in the nanometer unit. For example, the average size of the mesoporous tungsten oxynitride nanoparticles may be in the range of 1 nm to 100 nm.

As described above, the ionic conductivity and mechanical strength may be further improved by further controlling the content depending on the form of the mesoporous tungsten oxynitride nanomaterial. Specifically, if the mesoporous tungsten oxynitride nanomaterial is mesoporous tungsten oxynitride nanofibers, the range thereof is also controlled unlike those described above. At this time, the content of the mesoporous tungsten oxynitride nanofibers may be in the range of 10 parts by weight to 20 parts by weight with respect to 100 parts by weight of the polymer component. The lower limit of the range (unit: parts by weight) may be 13, 15, 17 or 19.

In addition, if the mesoporous tungsten oxynitride nanomaterial is mesoporous tungsten oxynitride nanoparticles, the range thereof is also controlled unlike those described above. At this time, the content of the mesoporous tungsten oxynitride nanoparticles may be in the range of 5 parts by weight to 20 parts by weight with respect to 100 parts by weight of the polymer component. The lower limit of the range (unit: parts by weight) may be 6, 7, 8, 9 or 10. The upper limit of the range (unit: parts by weight) may be 15, 14, 13, 12, 11 or 10.

Furthermore, if the mesoporous tungsten oxynitride nanomaterial is the mixture of the mesoporous tungsten oxynitride nanofibers and the mesoporous tungsten oxynitride nanoparticles, the range thereof is also controlled unlike those described above. In this case, it is preferable to simultaneously control the content in the composition of the mixture itself and the mixing ratio of nanoparticles and nanofibers in the mixture.

Here, the content of the mixture of the mesoporous tungsten oxynitride nanofibers and the mesoporous tungsten oxynitride nanoparticles may be in the range of 15 parts by weight to 25 parts by weight with respect to 100 parts by weight of the polymer component. The lower limit of the range (unit: parts by weight) may be 16, 17, 18, 19 or 20. The upper limit of the range (unit: parts by weight) may be 25, 24, 23, 22, 21 or 20.

In addition, in the mixture of the mesoporous tungsten oxynitride nanofibers and the mesoporous tungsten oxynitride nanoparticles, a weight ratio (NF/NP) of the mesoporous tungsten oxynitride nanofibers (NF) and the mesoporous tungsten oxynitride nanoparticles (NP) may be in the range of 0.7 to 1.5. The lower limit of the ratio may be 0.8, 0.9 or 1.0. The upper limit of the ratio may be 1.4, 1.3, 1.2, 1.1 or 1.0.

The polymer solid electrolyte composition for the lithium secondary battery of the present disclosure may further include other known components in addition to the components described above, within the scope of securing the effects of the present disclosure.

### Polymer Solid Electrolyte for Lithium Secondary Battery

The present disclosure relates to a polymer solid electrolyte for a lithium secondary battery. The present disclosure excludes a solvent from the polymer solid electrolyte composition for the lithium secondary battery described above. Therefore, the electrolyte of the present disclosure includes a polymer component; a lithium salt; and a mesoporous tungsten oxynitride nanomaterial having a composition of Chemical Formula 1. In addition, the contents mentioned in the composition of the present disclosure are also applied to the electrolyte. Therefore, if the configuration mentioned while explaining the composition of the present disclosure is also present in the electrolyte of the present disclosure, the same content may be applied.

The electrolyte of the present disclosure may be prepared using the composition of the present disclosure. For example, the electrolyte of the present disclosure may be prepared by drying the composition.

The polymer solid electrolyte for the lithium secondary battery of the present disclosure may further include other known components in addition to the components described above, within the scope of securing the effects of the present disclosure.

### Lithium Secondary Battery

The present disclosure relates to a lithium secondary battery. Specifically, the present disclosure relates to an all-solid-state lithium secondary battery. More specifically, the present disclosure is a lithium secondary battery including the aforementioned polymer solid electrolyte.

The lithium secondary battery of the present disclosure uses the polymer solid electrolyte of the present disclosure as an electrolyte, in a lithium secondary battery having a known structure. Therefore, the lithium secondary battery of the present disclosure includes a solid electrolyte layer including the polymer solid electrolyte for the lithium secondary battery; a cathode layer disposed on one side of the solid electrolyte layer; and an anode layer disposed on the other side of the solid electrolyte layer so as to face the cathode layer.

The lithium secondary battery of the present disclosure may further include other known components in addition to the components described above, within the scope of securing the effects of the present disclosure.

Hereinafter, the present disclosure will be described in more detail by Examples. However, the scope of the present disclosure is not limited to the following Examples.

### Example 1

### 1. Materials

(1) As a polymer component, PAN (Aldrich) was used.
(2) As a lithium salt, LiPF₆ (Aldrich) was used.
(3) As an organic solvent, ethyl carbonate was used.
(4) A mesoporous tungsten oxynitride nanomaterial was prepared as follows.
   1) A commercial mesoporous tungsten oxide (Aldrich) was obtained and heat-treated with ammonia gas to prepare mesoporous tungsten oxynitride particles.
   2) A commercial mesoporous tungsten oxide (Aldrich) was obtained, electrospun in the form of fibers, heat-treated, and then heat-treated with ammonia gas to prepare mesoporous tungsten oxynitride fibers.
   3) The composition of the mesoporous tungsten oxynitride nanomaterial was analyzed by EDS and XPS. TEM-EDS was performed with HR-TEM, FEI Talos F200X equipment. At this time, the sample was dispersed in ethanol and applied. XPS was performed with hermo VG Scientific K-Alpha. In XPS, samples were not separately prepared.

Table 1 below summarizes the characteristics of mesoporous tungsten oxynitride nanoparticles and mesoporous tungsten oxynitride nanofibers used in the present disclosure. Here, the pore sizes and specific surface areas of the nanoparticles and nanofibers were measured by BET analysis. BET was performed on Micromeritics 3Flex equipment. At this time, the samples were pre-dried at 100° C. and then applied.

TABLE 1

| | Specific | Average | Pore | |
|---|---|---|---|---|
| | surface area | size | size | |
| | (m²/g) | (nm) | (nm) | Component |
| Nanoparticles | 27 | 100 | 6.5 | WO_{0.5}N_{0.5} |
| Nonofibers | 33 | 80 | 7 | WO_{0.5}N_{0.5} |

### 2. Evaluation

### (1) Ionic Conductivity

In Examples and Comparative Examples, a polymer solid electrolyte was placed between ionic conductivity measurement cells with a 20 mm diameter consisting of upper and lower surfaces made of SUS plates and bonded to prepare a specimen. The impedance of this specimen was measured to obtain a resistance value. The ionic conductivity of the polymer solid electrolyte was measured by substituting the obtained resistance value into Equation “ionic conductivity=thickness/(area*resistance)”.

### (2) Tensile Strength

In Examples and Comparative Examples, a polymer solid electrolyte was cut into length*width (1 cm*5 cm) to prepare a specimen. For this specimen, tensile strength was measured using a tensile strength meter (Instron UTM machine) according to ASTM D638 standard.

### (3) Measurement of Discharge Capacity Retention Rate

In Examples and Comparative Examples, a coin cell was manufactured using the polymer solid electrolyte. Specifically, a cathode of the coin cell was an NCM811 electrode, and an anode was a lithium metal electrode. While the polymer electrolyte prepared above was periodically charged and discharged at 0.3 C using a coin cell power converter (Warnatech product), the discharge capacity that decreased as the number of charge and discharge cycles increased was measured. Next, the measured discharge capacity was converted into a % ratio based on an initial discharge capacity.

### 3. Preparation

### (1) Polymer Solid Electrolyte Composition

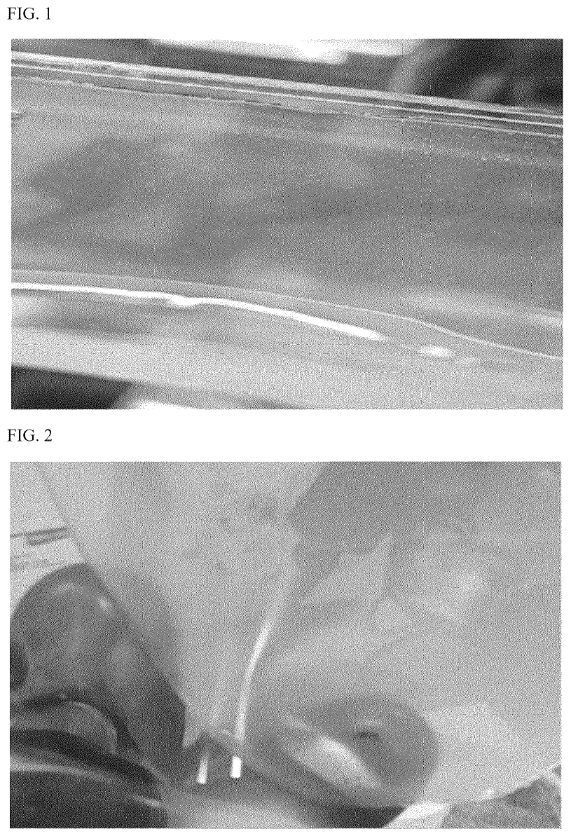

In a container containing an organic solvent, 10 parts by weight of a polymer component with respect to 100 parts by weight of a solvent was dissolved. When the polymer component was fully dissolved, 6 parts by weight of a lithium salt with respect to 100 parts by weight of the solution was further dissolved in the container. In the container in which the polymer component and lithium were dissolved, 5 parts by weight of nanoparticles were added with respect to 100 parts by weight of the polymer component. The mixture was dispersed for 3 minutes using a ball mill to obtain a polymer solid electrolyte composition. FIG. 1 is a photograph of the polymer solid electrolyte composition prepared above.

### (2) Polymer Solid Electrolyte

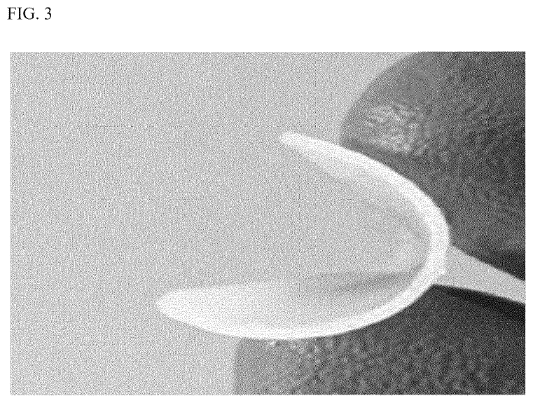

A polymer solid electrolyte composition was blade-coated on a glass plate with a thickness of 50 μm. After coating, a polymer solid electrolyte was obtained by drying in a vacuum oven at 95° C. for 1 hour. FIGS. 2 and 3 are photographs of the polymer solid electrolyte of Example.

### Examples 2 to 9 and Comparative Example

The same process as Example 1 was repeated, except that the composition of the polymer solid electrolyte composition was changed to compositions described in Tables 2 and 3.

### 4. Result

Tables 2 and 3 show the compositions and evaluation results of Examples and Comparative Example.

TABLE 2

| | | Unit | Com. Ex. | Ex. 1 | Ex. 2 | Ex. 3 | Ex. 4 |
|---|---|---|---|---|---|---|---|
| Polymer component | | Parts by weight | 10.5 | 10.5 | 10.5 | 10.5 | 10.5 |
| Lithium salt | | Parts by weight | 7.5 | 7.5 | 7.5 | 7.5 | 7.5 |
| Solvent | | Parts by weight | 82 | 82 | 82 | 82 | 82 |
| Oxynitride | Nanoparticles | Parts by weight | | 0.525 | 1.05 | 2.1 | |
| | Nonofibers | Parts by weight | | | | | 0.525 |

| | | | | | | |
|---|---|---|---|---|---|---|
| Ionic conductivity | (mS/cm) | 1 | 1.5 | 2.2 | 2 | 2.1 |
| Tensile strength | (MPa) | 1 | 1.4 | 1.8 | 2.1 | 2.4 |
| Discharge capacity retention | (%@100 cycle) | 60 | 78 | 78 | 78 | 80 |
| rate | | | | | | |

TABLE 3

| | | Unit | Ex. 5 | Ex. 6 | Ex. 7 | Ex. 8 | Ex. 9 |
|---|---|---|---|---|---|---|---|
| Polymer component | | Parts by weight | 10.5 | 10.5 | 10.5 | 10.5 | 10.5 |
| Lithium salt | | Parts by weight | 7.5 | 7.5 | 7.5 | 7.5 | 7.5 |
| Solvent | | Parts by weight | 82 | 82 | 82 | 82 | 82 |
| Oxynitride | Nanoparticles | Parts by weight | | | 0.525 | 1.05 | 1.575 |
| | Nonofibers | Parts by weight | 1.05 | 2.1 | 0.525 | 1.05 | 1.575 |

| | | | | | | |
|---|---|---|---|---|---|---|
| Ionic conductivity | (mS/cm) | 2.2 | 2.3 | 1.8 | 2.4 | 1.2 |
| Tensile strength | (MPa) | 2.7 | 3.2 | 1.7 | 3 | 2.8 |
| Discharge capacity retention | (%@100 cycle) | 80 | 80 | 80 | 83 | 75 |
| rate | | | | | | |

The ionic conductivity and mechanical strength (tensile strength) of the polymer solid electrolyte prepared with the composition defined in the present disclosure are much superior to those of other compositions undefined in the present disclosure.

1. A polymer solid electrolyte composition for a lithium secondary battery comprising:
a polymer component;
an organic solvent;
a lithium salt; and
a mesoporous tungsten oxynitride nanomaterial having a composition represented by the following Chemical Formula 1: 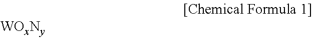
In Chemical Formula 1, x and y are 0.5 to 2.5, respectively.

2. The polymer solid electrolyte composition for the lithium secondary battery of claim 1, wherein the pore size of the mesoporous tungsten oxynitride nanomaterial is in the range of 3 nm to 10 nm.

3. The polymer solid electrolyte composition for the lithium secondary battery of claim 1, wherein the content of the mesoporous tungsten oxynitride nanomaterial is in the range of 5 parts by weight to 30 parts by weight with respect to 100 parts by weight of the polymer component.

4. The polymer solid electrolyte composition for the lithium secondary battery of claim 1, wherein the mesoporous tungsten oxynitride nanomaterial is at least one of mesoporous tungsten oxynitride nanofibers and mesoporous tungsten oxynitride nanoparticles.

5. The polymer solid electrolyte composition for the lithium secondary battery of claim 4, wherein the mesoporous tungsten oxynitride nanomaterial is mesoporous tungsten oxynitride nanofibers, and
the content of the mesoporous tungsten oxynitride nanofibers is in the range of 10 parts by weight to 20 parts by weight with respect to 100 parts by weight of the polymer component.

6. The polymer solid electrolyte composition for the lithium secondary battery of claim 4, wherein the mesoporous tungsten oxynitride nanomaterial is a mixture of mesoporous tungsten oxynitride nanofibers and mesoporous tungsten oxynitride nanoparticles,
the content of the mixture of the mesoporous tungsten oxynitride nanofibers and the mesoporous tungsten oxynitride nanoparticles is in the range of 15 parts by weight to 25 parts by weight with respect to 100 parts by weight of the polymer component, and
in the mixture of the mesoporous tungsten oxynitride nanofibers and the mesoporous tungsten oxynitride nanoparticles, a weight ratio (NF/NP) of the mesoporous tungsten oxynitride nanofibers (NF) and the mesoporous tungsten oxynitride nanoparticles (NP) is in the range of 0.7 to 1.5.

7. A polymer solid electrolyte for a lithium secondary battery comprising:
a polymer component;
a lithium salt; and
a mesoporous tungsten oxynitride nanomaterial having a composition represented by the following Chemical Formula 1: 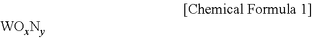
in Chemical Formula 1, x and y are 0.5 to 2.5, respectively.

8. A lithium secondary battery comprising:
a solid electrolyte layer containing the polymer solid electrolyte for the lithium secondary battery according to claim 7;
a cathode layer disposed on one side of the solid electrolyte layer; and
an anode layer disposed on the other side of the solid electrolyte layer so as to face the cathode layer.
